(19) United States
(12) Patent Application Publication
(10) Pub. No.: US 2008/0069412 A1
(43) Pub. Date: Mar. 20, 2008

(54) Contoured biometric sensor

(76) Inventors: Katrina S. Champagne, Palmer, MA (US); Joseph J. Turek, Palmer, MA (US); Robert J. Encarnacion, Van Nuys, CA (US)

Correspondence Address: ASHOK TANKHA;OF COUNSEL, LIPTON, WEINBERGER & HUSICK, 36 GREENLEIGH DRIVE, SEWELL, NJ, 08080, US

(21) Appl. No.: 11/521,622

(22) Filed: Sep. 15, 2006

(51) Int. Cl. G06K 9/00

(52) U.S. Cl. 382/124

(57) ABSTRACT

Disclosed herein is an apparatus and system for fingerprint recognition and hand-print recognition comprising a scanner with a contoured surface, or a scanner the surface of which deforms to allow more fingerprint or hand-print data to be captured, an application specific circuit for conversion of analog data from a captured fingerprint image from an embedded sensor array into a digital image and a fingerprint security application for verification of said digital image against stored fingerprint templates. The scanner array wrap with the embedded scanner array may be placed over the fixture to be scanned, or it may be formed as a part of the fixture that is scanned to authenticate the identity of a person.

### BACKGROUND OF THE INVENTION

This invention, in general, relates to a system and apparatus for facilitating authentication of the identity of an individual, and in particular relates to authentication by fingerprint and hand-print recognition using a contoured scanner, or a scanner the scanning surface of which adjusts to the contour of the fingerprint or hand-print when the finger or hand is applied on the scanner array or the scanner array wrap. The sensor array wrap and the sensor array embedded therein is also capable of deforming and adapting to the shape of the fixture on which the finger or hand is placed for scanning and identification purposes.

Fingerprint authentication systems currently in use have a scanner or reader that have a relatively flat surface thereby limiting the surface area of the fingerprint that is scanned, and therefore limiting the amount of biometric data that can be captured by the scanner. If the surface area of the finger or hand that comes in contact with the scanner is increased, more data can be captured and analyzed. There exists a need to increase the surface area of the fingerprint or hand-print that is scanned to allow a more accurate and rapid authentication of the identity of an individual.

There is also a need for the scanner to adapt to the shape, or be a part of the shape of the fixture on which the fingerprint or hand-print is placed to be scanned.

There is also a need for the sensor array wrap, or the sensor array if the sensor array directly contacts the finger or hand, to adapt to the shape of the finger or hand when pressure from a finger or hand is applied on the scanner to allow more fingerprint and hand-print biometric information to be captured.

There is a market need for an apparatus wherein the authentication processes using a contoured scanning surface is integrated within the biometric device or added to a biometric device's fixture, thus eliminating the need for providing a separate authenticating device and process for accessing a particular device.

### BRIEF DESCRIPTION OF THE DRAWINGS

The foregoing summary, as well as the following detailed description of the embodiments, is better understood when read in conjunction with the appended drawings. For the purpose of illustrating the invention, there is shown in the drawings exemplary constructions of the invention; however, the invention is not limited to the specific methods and instrumentalities disclosed herein.

FIG. 1 illustrates a biometric device for fingerprint and hand-print recognition.

FIG. 2 illustrates a biometric device for fingerprint and hand-print recognition.

FIG. 3A illustrates a cross-section of the layered structure of a sensor array wrap within which a sensor array is embedded.

FIG. 3B illustrates a sensor array embedded within layers of a sensor array wrap.

FIG. 4A illustrates contours that the scanner can be shaped into.

FIG. 4B illustrates a contour the scanner can be shaped into.

FIG. 5A illustrates a contoured shaped scanner to provide the user with a natural feel when the user's finger is placed over the sensor array wrap.

FIG. 5B illustrates a scanner comprising a scanner array and a scanner array wrap.

FIG. 5C illustrates deformation of the scanner under pressure, for example when a finger is placed on the surface of the scanner array wrap.

FIG. 5D illustrates a contoured scanner embedded in a car steering wheel.

FIG. 5E illustrates a scanner contoured around a joystick.

FIG. 6A illustrates a surface where the biometric scanning area is limited to one section of the surface.

FIG. 6B illustrates a surface where biometric scanning area is not limited to one section of the surface.

FIG. 7A illustrates the application of a scanner in a car steering wheel.

FIG. 7B illustrates the application of a scanner to a car steering wheel.

FIG. 8 illustrates the application of the scanner to a personal computer or a laptop.

FIG. 9 illustrates the application of the scanner in a mouse pad.

### DETAILED DESCRIPTION OF THE INVENTION

Disclosed herein is an apparatus and system for fingerprint recognition and hand-print recognition by a biometric device comprising a contoured scanner, or a scanner the scanning surface of which flexes or deforms to allow the bottom and curved sides of the finger or hand to be captured. The scanner comprises a sensor array embedded between two layers material of the sensor array wrap. In one embodiment of the invention, the sensor array is located on the upper surface of the top layer of the sensor array wrap. The sensor array captures the fingerprint image or hand-print image when the finger or hand is placed on the scanning surface. An authentication security application module authenticates a user using the captured fingerprint or hand-print image against stored fingerprint and hand-print templates.

As used herein, a sensor array is a multiplicity of fingerprint and handprint sensors collocated to form a sensor array. The fingerprint and hand-print sensor array may be any one or a combination of any of the fingerprint sensor array types, for example, capacitive, optical, thermal, ultrasonic or tactile fingerprint sensor. As used herein, a sensor array wrap is the material within which the sensor array is embedded.

In one embodiment of the invention, the scanner can be over-laid on a fixture, or positioned to adapt to the shape of a fixture on which the person would place his finger or hand, to allow his or her fingerprint or hand-print to be scanned and the person's identity authenticated. An example of such a fixture is a door-knob.

In another embodiment of the invention, the scanner array wrap can be molded or configured into the shape of a fixture on which the person would place his finger or hand to authenticate his or her identity, for example, the scanner array can be molded into the shape of a door-knob.

In another embodiment of the invention, the scanner array wrap is contoured or recessed to allow the bottom and the sides of the fingerprint or hand-print to be scanned when the finger or hand is placed on the scanner array wrap.

In another embodiment of the invention, the scanner array is embedded on the surface of the scanner array wrap, and the scanner array is contoured or recessed to allow the bottom and the sides of the fingerprint or handprint to be scanned when the finger or hand is placed on the scanner array.

In another embodiment of the invention, the scanner including the scanner array wrap and the scanner array flex or deform to allow a larger surface area of the finger or hand to be read more accurately and comprehensively by the sensor array when the finger or hand is applied to the surface of the scanner, thereby allowing the capture of more biometric information of the fingerprint or hand-print.

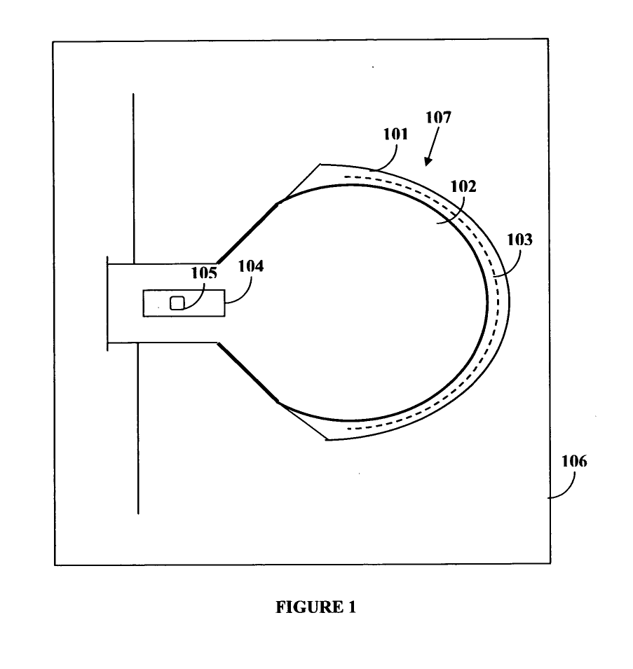

FIG. 1 illustrates a biometric device 106 for fingerprint and hand-print recognition where the scanner 107 comprises the sensor array 103 embedded within a sensor array wrap 101. In this example, the scanner 107 is shown over-laid or enveloping the surface of a door-knob 102. When a person places his hand on the door-knob 102 to open the door, the sensor array 103 captures the fingerprint or hand-print information of that person. The sensor array 103 thereafter transmits the data captured to a fingerprint security application module 104 in-built in the biometric device 106. The fingerprint security application module 104 uses an application specific integrated circuit (ASIC) 105 to perform the recognition and authentication process by converting the fingerprint and hand-print information captured by the sensor array 103 into its digital equivalent. The fingerprint security application module 104 then compares the captured fingerprint image with the fingerprint templates of the registered users present in the fingerprint template database to authenticate the identity of the person that placed his or her hand on the door-knob 102.

As used herein, the term fingerprint security application module is a module capable of processing the finger-print and hand-print information for authentication purposes.

Embedding contoured or flexible sensor arrays in a sensor array wrap allows the integration of the sensor array into a biometric device or fixture, and allows for its easy replacement. For example, an integrated scanner on a car steering wheel would only require the replacement of the scanner 107 and not the entire steering wheel if the scanner is damaged.

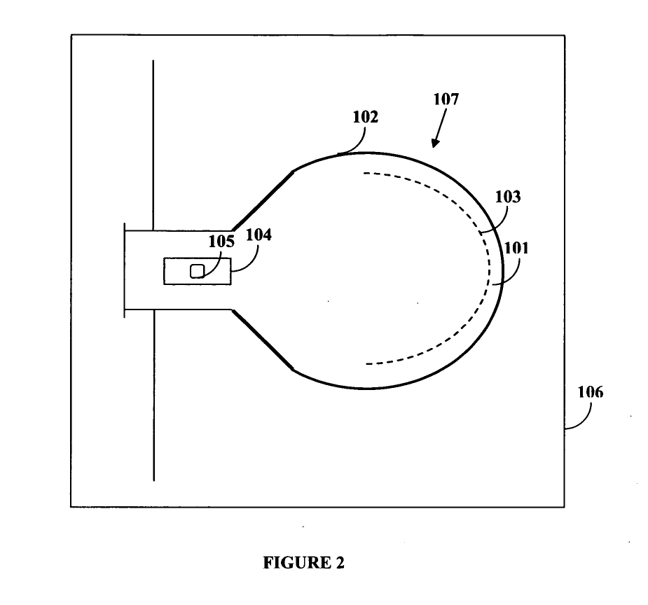

FIG. 2 illustrates a biometric device 106 for fingerprint and hand-print recognition comprising a scanner 107 formed or molded in the shape of a door knob 102, a fingerprint security module 104 and the application specific integrated circuit module 105. In this example, the scanner comprising the sensor array wrap 101 and the embedded sensor array 103 scans the fingerprint or hand-print when the person places his or her finger or hand on the door-knob 102. The fingerprint or hand-print data scanned by the scanner array 103 is transmitted to the fingerprint security application module 104 which processes the fingerprint information for verification and recognition by digital processing of the image scanned. The fingerprint security application module 104 uses an application specific integrated circuit (ASIC) 105 to perform the recognition and authentication process by converting the fingerprint and handprint information captured by the sensor array 103 into its digital equivalent. The fingerprint security application module 104 then compares the captured fingerprint image with the fingerprint templates of the registered users present in the fingerprint template database to authenticate the identity of the person that placed his or her hand on the door-knob 102. The door lock is in direct communication with the fingerprint security application module 104 and is enabled only when the fingerprint security application module 104 confirms that the captured fingerprint is that of a registered user.

The fingerprint and hand-print data capturing scanner 107 comprising the sensor array wrap 102 and the embedded sensor array 103 is capable of being shaped into various configurations and may form the fixture or a part of the fixture that scans or reads the fingerprint or hand-print. The scanner 107 may also be positioned and sized to be placed in specific and predefined areas of the fixture to read a person's fingerprint or hand-print.

The sensor array may consist of any fingerprint or handprint sensing technology for example, transistors and pressure sensing, capacitance sensing and light sensing arrays. These sensor arrays are very sensitive and are capable of detecting the fingerprint image mapped by light or charge even when the sensor array is placed below a layer of an appropriate sensor wrap 101 on the fixture where the finger or hand is placed for scanning and authentication.

The optical fingerprint sensors enable non-contact fingerprint image detection with a high degree of accuracy. Human fingers consist mainly of three layers, namely-scarfskin, inner skin, and tissues under the skin. The inner skin has concavo-convex shaped formations, called ridge and valleys. The scarfskin which shows the shapes present on the inner skin, define the fingerprint of the person. As light is transmitted through the tissue a unique pattern of transmittance of light depending on the concavo-convex formation on the inner skin is generated. Each fingerprint has a unique pattern of concavity and convexity and thus each of them generates a pattern that can be distinguished from another. These optical finger-print sensors have low maintenance, high resolution and are resistant to shock and electrostatic discharge.

The capacitive fingerprint sensor, as the name implies, works on the principle of capacitance. Capacitance can be defined as the ability to hold electrical charge. The capacitive finger-print sensor eliminates the limitations of optical scanners such as edge distortion, misaligned optics, low-image resolution and scratched platens. Normally, parallel plate sensors are employed for fingerprint scanning applications. A capacitive fingerprint sensor may contain many thousands of capacitive plates, each of which has its own associated electrical circuitry embedded in the form of integrated chips. When a finger is placed on the sensor, an extremely weak electrical charge is generated. This electrical current builds up in a pattern that is determined by the capacitances corresponding to the ridges, valleys and pores that characterize a fingerprint. Every fingerprint has a unique electrical current pattern associated with it. The sensor can be made more accurate and reliable using programmable logic, internal to the capacitive sensor circuitry and the sensor reception can also be adjusted to different skin types and environmental conditions.

Thermal fingerprint sensors use micro heaters as the sensing element. The sensing elements are formed into a sensor array. The sensing elements are micro resistors made of sputtered, very fine platinum film and are placed on a flexible polyamide film substrate. There exists a temperature difference between the skin ridges and the air entrapped in the fingerprint valleys. The sensor measures this temperature differential to map the fingerprint image. The advantage of using this method is that it is capable of generating a high quality image even on poor quality fingerprints, for example, on finger-prints that are dry, worn or with little depth between the peaks and valleys of the fingerprint. These sensors can also be used under adverse conditions like extremes of temperature, high humidity, dirt, and oil or water contamination.

Another type of sensor commonly used for fingerprint sensors is the tactile fingerprint sensor. It works on the principle of change in resistivity of a peizoresistive material. As a user passes his finger over the sensor array, deflections in the microbeam occur. This deflection corresponds to the ridges and the valleys that characterize the fingerprint. Fingerprint detection is based on the measurement of this deflection. The deflection which is a measure of the resistivity can be measured by a piezoresistive gauge. The sensor array includes electronic controls that are necessary to scan the row of microbeams and to amplify the signal from the gauges.

Ultrasonic sensor arrays are also used for fingerprint recognition. They employ the basic theory of reflection, diffraction and scattering. When two solid objects are placed against each other, the contact between the surfaces of the two objects is not perfect, i.e., inhomogeneities exist between the surfaces. As sound waves travel through these surfaces they undergo a phenomenon called contact scattering, along with getting reflected, diffracted and scattered as explained by classical theory of light. This phenomenon effects the sound propagation in the area of contact between the two objects. Using an ultrasonic camera the contact scattered rays are measured to generate the fingerprint image.

In another embodiment of the invention, light-emitting-polymer (LEP) technology may be used. Light emitting polymers, also called electroluminescent polymers are organic light emitting materials that emit light when they are excited by an electric current. The electroluminescent polymer can be coated over a variety of transparent substrates. The electroluminescent polymer forms the sensor array wrap 101. The transparent fixture through which the fingerprint is to be scanned forms the light medium.

It also forms the base over which the electroluminescent polymer layer is wrapped. The light medium may be any transparent medium capable of being molded into various shapes, depending on the application. The transparent fixture transmits the light from the electroluminescent polymer to a detector array placed in the fixture to capture the illumination from the electroluminescent polymer. The detector array generates the electrical equivalent of the fingerprint image via the associated embedded electronics circuitry. The image data is in turn transferred to the fingerprint security application module 104 for enrollment or verification.

As used herein, the term “transparent fixture” comprises a fixture that is transparent to visible light and also to fixtures that transmit radiation from an electroluminescent polymer.

In one embodiment of the invention a single type of sensor is used to build the embedded sensor array 103. In another embodiment of the invention, the fingerprint security application module 104 may use more than one type of sensor. For example, a combination of optical fingerprint sensors and capacitive fingerprint sensors may be used. The fingerprint identification module 104 may be located within a fixture, or be located in a remote server. The fingerprint security application module employs ASIC 105 for the processing of the captured information. Different fingerprint image processing techniques may be used for parallel processing of the captured fingerprint image. Application of selective, plural and sequenced fingerprint recognition rules is another embodiment of the invention. The selective, plural and sequenced fingerprint recognition rules, as explained in the patent application titled “Selective, plural and sequenced (SPS) fingerprint recognition”, application Ser. No. 11/511,146, make the verification process faster, reliable and more accurate.

When the finger or hand grips the biometric fixture 106 enveloped in the sensor array wrap 101 as shown in FIG. 1 or in FIG. 2, the captured fingerprint image may have any random orientation. Fingerprint reconstruction algorithms have to be applied to process the fingerprint image to extract the required information from the fingerprint image. Depending on the information furnished by the reconstructed image, the relevant selective, plural and sequenced fingerprint recognition rules that have to be applied to that reconstructed fingerprint image are determined by the fingerprint security application module 104. There is a predetermined sequence of application of the selective, plural and sequenced fingerprint recognition rules. Minutiae matching and correlation matching are examples of techniques used for fingerprint matching.

Minutiae points are local ridge characteristics that occur at either a ridge bifurcation or a ridge ending. For the registered user's finger-print image, all the minutiae points, orientations and structural relationship of the points are detected and stored in the form of templates. During the fingerprint matching process, the scanned fingerprint is compared against the minutiae points of the fingerprint templates in the fingerprint template database. The algorithm for minutiae matching, in the first stage, determines the presence of same minutiae, for example, a bifurcation. If the presence of the same minutiae is confirmed then the algorithm goes on to check if the direction of minutiae flow is also the same as that in the fingerprint image present in the fingerprint store. The final step of the minutiae-matching algorithm takes place only after both these conditions are fulfilled. The locations of the minutiae are determined and it is checked if the minutiae occupy the same position relative to each other.

Image distortion occurring due to displacement and elastic deformation can be nullified by image enhancement techniques and matching algorithm. For example, distortions that occur due to elastic deformation of the image due to excess finger pressure applied are checked and eliminated by image enhancement techniques. Minutiae matching algorithms address the errors occurring during feature extraction.

Correlation matching is a technique that overcomes the disadvantages of the minutiae-based approach. Thus, fingerprint correlation provides improved performance over the minutiae matching technique. In the correlation matching technique, the scanned fingerprint is compared against fingerprints stored in the fingerprint template using more than one method. This technique is very useful in overcoming the shortcomings of an individual technique.

The selective, plural and sequenced fingerprint recognition rules also comprise a plurality of ridge based fingerprint recognition rules. Ridge feature matching is another technique that may be used depending on the method of feature extraction. The algorithm depends on extracting texture, shape, frequency orientation and other ridge characteristics for matching.

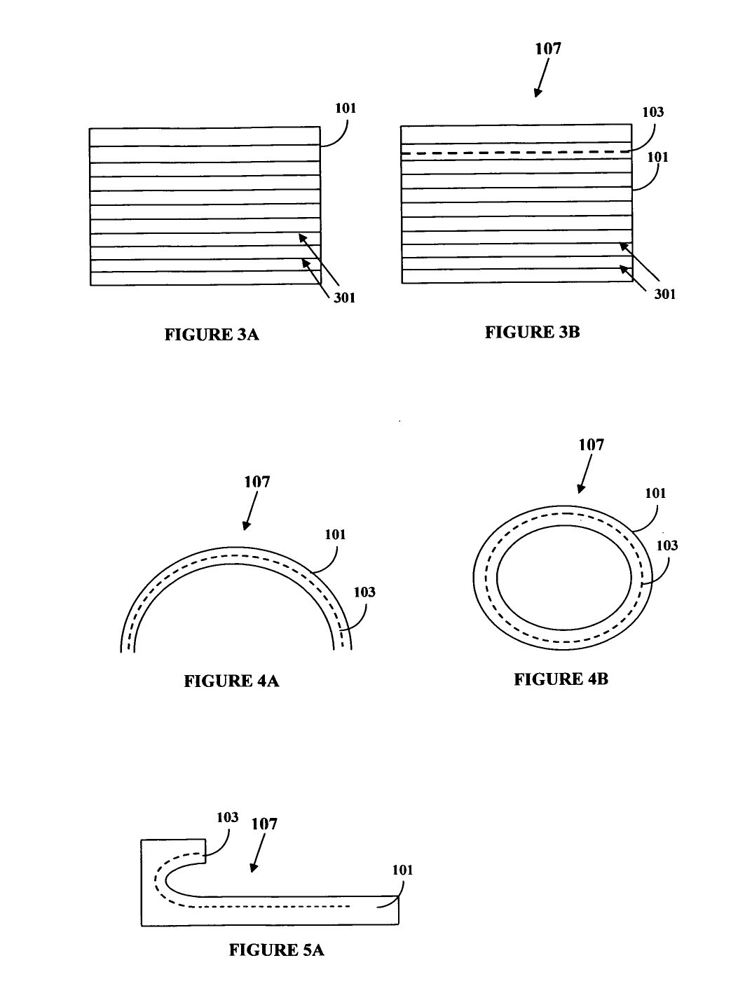

FIG. 3A illustrates a layered material structure used to manufacture the sensor array wrap 101 within which the sensor array is embedded. The material of the sensor array wrap 101 may have a single layer structure, or a number of very thin substantially parallel layers 301 of the material may be placed one above the other to create the layered structure of the sensor array wrap 101. The sensor array is embedded in one of the layers 301 of the material, or may be embedded on the upper surface of the top layer. The layer 301 of material above the sensor array also serves as a protective coating for the sensor array, preventing the direct exposure of the sensor array to the external environment. The sensor array wrap 101 may comprise any material through which the sensor array can sense or read the applied fingerprint or hand-print, for example, a plastic, synthetic or natural rubber, fiberglass, glass, etc. The sensor array wrap with the sensor array 103 embedded within it, or embedded on the upper surface of the top layer of the sensor array wrap may be flexible or non-flexible, and is capable of adapting to, or enveloping symmetric or non-symmetric fixtures. The sensor array wrap may be placed over or within a fixture.

FIG. 3B illustrates a scanner 107 comprising a sensor array 103 embedded within the layers of the material 301. The sensor array 103 is placed within the layers of the material 301 of the sensor wrap during the manufacturing process. In one process, the sensor array is infused between two layers of material 301 of the sensor wrap. Mold enclosure injection, casing injection, or thin fiber-glass layering are a few other examples of the manufacturing processes used to embed a sensor array 103 within the layers of the material 301 to fabricate the sensor wrap 101. A typical process for placing a sensor array 103 in a material 301 is to cut out a piece of the material 301 to be integrated into the fixture and then have the predetermined sized sensor array plugged into or snapped into the dedicated part of the material 301. The sensor wrap 101 thus formed is integrated into the fixture.

FIGS. 4A and 4B illustrate configurations the sensor wrap 101 can be shaped into. The sensor wrap 101 can be formed or adapted to the shape of the fixture over which it is placed. For example, if the fixture over which the fingerprint is to be scanned is a door-knob, the sensor wrap 101 may be shaped to adapt to the shape of the appropriate part of the door-knob.

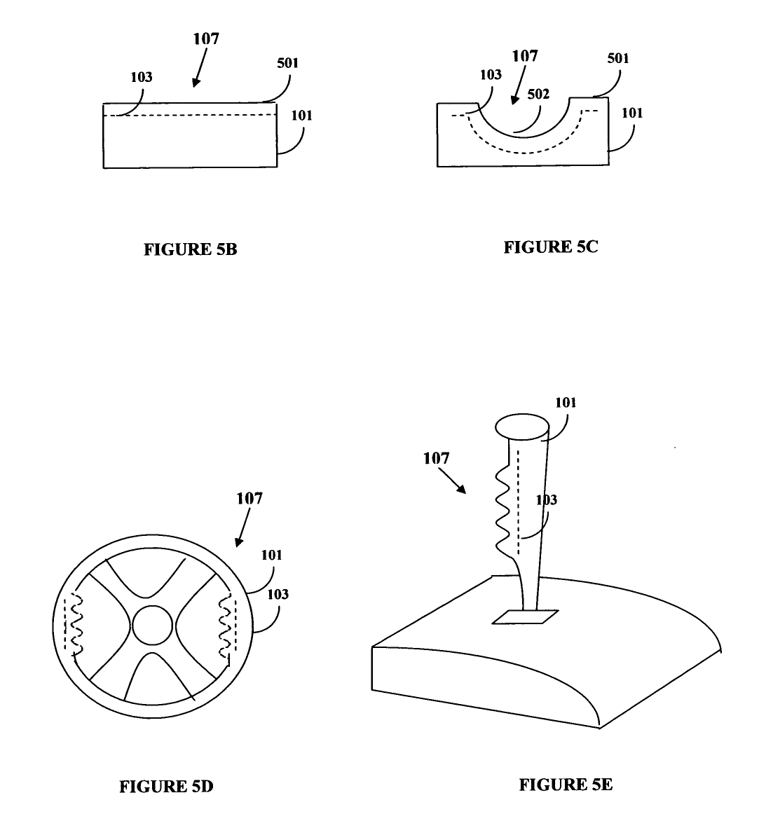

FIG. 5A illustrates a curved shape imparted to the sensor wrap 101 and the embedded sensor array 103 to provide a natural feel to a user when the user places his or her finger on the scanner 107 placed over a fixture. This ergonomic design of the scanner also facilitates the capture of more fingerprint information.

FIGS. 5B and 5C illustrates a rectangular shaped biometric sensing surface of a scanner 107 comprising the sensor wrap 101 and the embedded sensor array 103. The sensor wrap 101 is resilient in nature, capable of deforming under the pressure of an applied finger or hand. When a finger is placed on the scanning surface of the scanner 107, the pressure exerted on the surface 501 deforms to adapt to the bottom surface and side of the applied finger 502, thereby allowing the embedded sensor array 103 to capture more fingerprint information.

FIG. 5D illustrates an application of a contoured sensor wrap 101. The scanner 107 comprising a shaped sensor wrap 101 with an embedded sensor array 103 forms the surface of a car steering wheel. The contoured sensor wrap 101 imparts a natural feel when the user grips the steering wheel.

FIG. 5E illustrates an application of a scanner 107 comprising a contoured sensor wrap 101 with an embedded sensor array 103 on a joystick.

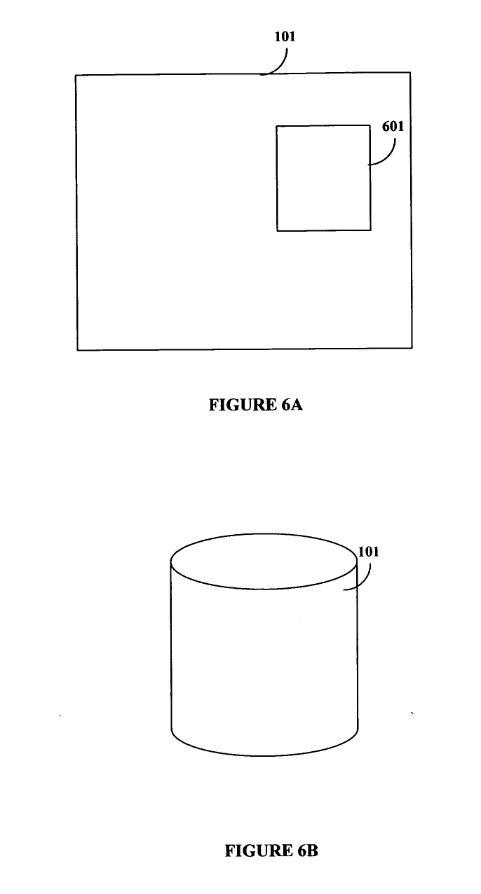

FIG. 6A illustrates the surface of a sensor array wrap 101 where the sensing area 601 is limited to a part of the fixture surface. To activate the authentication process, the user applies his finger or hand only on the surface 601 of the sensor array wrap which contains an embedded sensor array below the surface 601 (not shown in FIG. 6A).

FIG. 6B illustrates a cylindrical fixture where a finger or hand can be scanned when applied to any part of the cylindrical surface. The scanner comprising the scanner array wrap 101 with an embedded sensor array is applied over the surface of the cylinder. Such an arrangement ensures that the fingerprint or hand-print placed at random on any part of the cylindrical fixture will activate the authentication process.

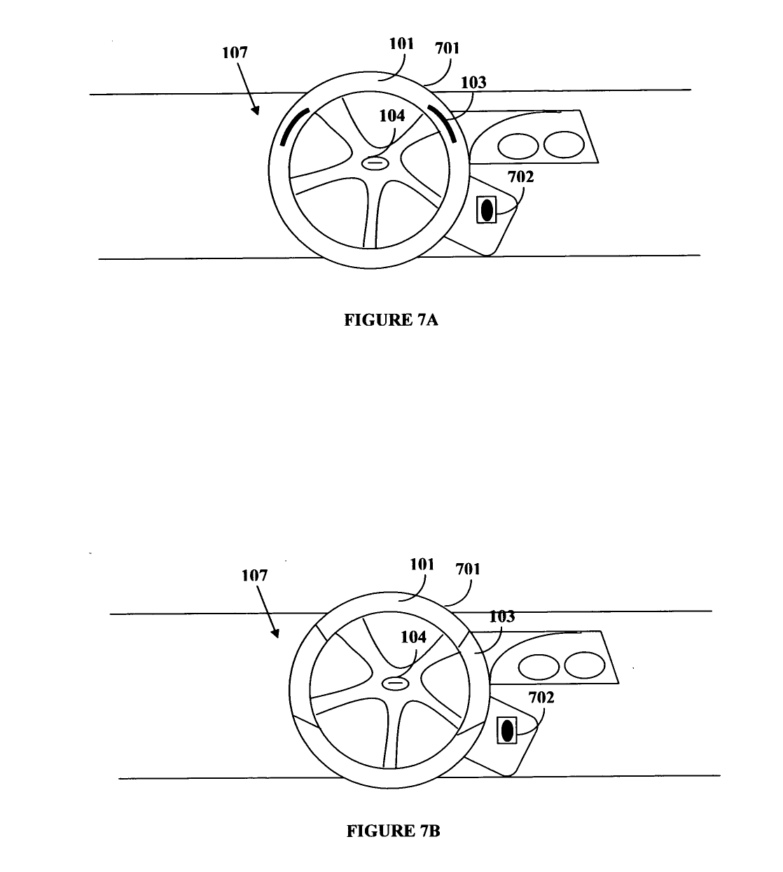

FIGS. 7A and 7B illustrates the application of the invention to a car steering wheel. FIGS. 7A and 7B illustrates a circular shaped scanner 107 configured to the contour of a steering wheel. The surface of the scanner 107 deforms under the pressure applied by the finger or hand of a user. The sensor array wrap 101 with embedded sensor array 103 forms the outer surface layer of a car steering wheel 701. The sensing area can be limited to a localized area over the wheel as shown in FIG. 7A, or may be adapted to a larger sensing area as shown in FIG. 7B. The wheel has a fingerprint identification module 104 embedded within it. When the user is authenticated, the car lock 702 receives a command from the fingerprint identification module. In the event a match is not found between the captured fingerprint image and the fingerprint templates stored in the database, the lock 702 is disabled, rendering the car steering wheel 701 immovable.

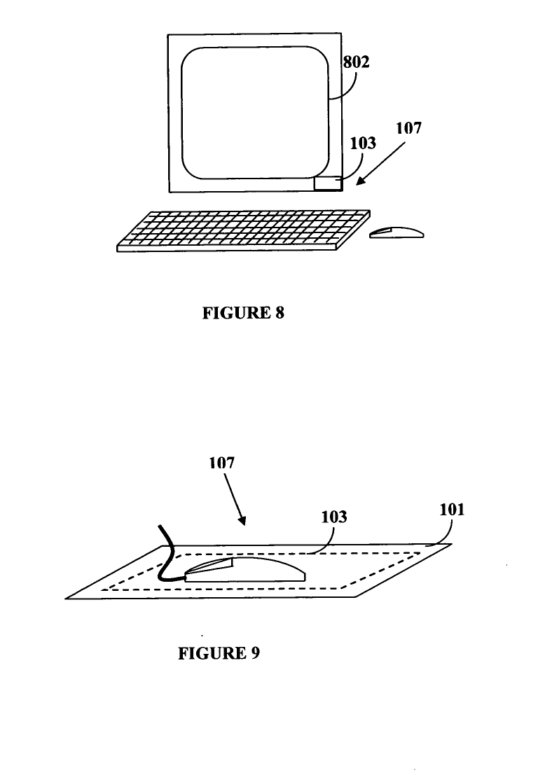

FIG. 8 illustrates the application of the invention to a personal computer or a laptop. The sensing area of the scanner 107 comprising the scanner array wrap and the embedded sensors 103 is limited to a small section on the screen of the computer or laptop. As the user places his finger on the touch screen 802 or touch pad in the process of turning on or logging into the system, the sensor array 103 captures the fingerprint and uses the fingerprint information to authenticate the identity of the user.

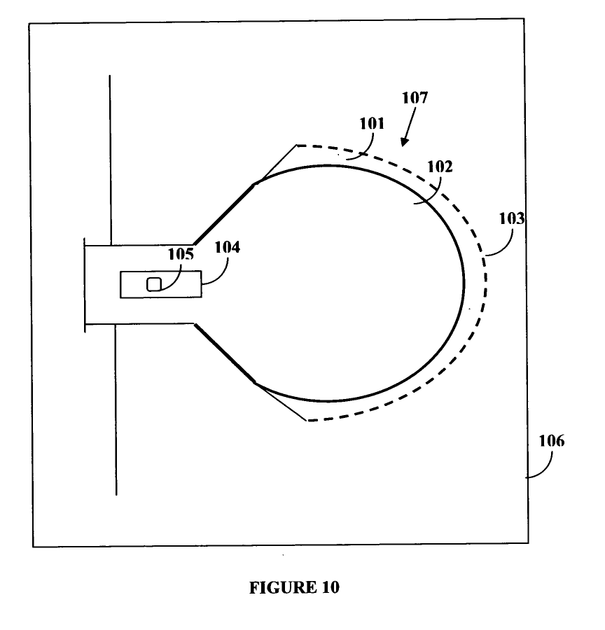

FIG. 9 illustrates the application of the invention to a mouse pad. In this application the scanner 107 is configured as a mouse pad. The surface of the mouse pad is made up of the sensor array wrap 101 with an embedded sensor array 103 for capturing the fingerprint and hand-print information when the user places his or her hand on the senor wrap 101 surface while operating the mouse. In one embodiment of the invention, the scanner may form the touch pad of a laptop.

FIG. 10 illustrates a scanner where the scanner array 103 is embedded on the surface of the sensor array wrap 101 which can flex or deform to adapt to the shape of the applied finger when the finger or hand is applied to the surface of the scanner array 103. The scanner array 103 is contoured to scan the bottom surface and sides of the finger of a user when the user places his finger or hand on the door-knob 102.

The method and system disclosed herein allows the scanner to fit the shape, or be lined, or over-laid on the surface of an object from which the fingerprint is to be scanned.

The method and system disclosed herein also allows authentication over multiple points of contact of a fingerprint or handprint, thereby allowing a robust capture of biometric information of the data captured from the fingers and hand by the sensor array.

The method and system disclosed herein can incorporate existing fingerprint and hand-print sensing technology. Sensing device arrays such as transistors, pressure sensing, capacitance sensing and light sensing arrays may be used in the scanner sensing device. The advantage of using light-emitting-polymer (LEP) technology over the existing semiconductor technology is its low power consumption, higher contrast, higher speed, wider viewing angle and minim size and weight.

The method and system disclosed herein also allows the integration of the biometric system into a fixture, for example a door knob, thereby permitting “natural” and ergonomic biometric authentication, without the user having to search for the area on which their finger needs to be placed for biometric authentication. The user can simply perform the normal handling of the biometric device, such as gripping a doorknob in a natural manner, and the biometric authentication process is performed non-intrusively.

The method and system disclosed herein also allow the cost effective replacement of a biometric sensing system. The overlay of a biometric sensor array shaped or embedded within a fixture allows replacement of biometric sensors that have the sensing surface confined to a limited sensor area.

The method and system disclosed herein also allow the cost effective integration the biometric sensing system during the manufacturing process of the fixture. The biometric sensor is systematically integrated into the fixture during the production of the material, encapsulation or enclosure of the fixture.

The method and system disclosed herein also allow discrete monitoring of users. For example, the non-intrusive system and apparatus of the present invention of authentication and monitoring can be applied on a door-knob, and the look and feel of the door-knob will not indicate an obvious incorporation of a biometric sensor array in the knob.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitations. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspect.

We claim:

1. A biometric device for fingerprint recognition, comprising:
a scanner,
said scanner having a contoured scanning surface,
said scanner comprising a sensor array wrap, and a sensor array embedded in said sensor array wrap,
an application specific circuit for conversion of analog data from a captured fingerprint image from said sensor array into a digital image; and,
a fingerprint security application for verification of said digital image against stored fingerprint templates.

2. The system of claim 1, wherein the sensor wrap is selected from the group consisting of plastic, synthetic or natural rubber, glass and fiberglass.

3. The system of claim 1, wherein the scanner is over-laid on a fixture, or forms a part of the fixture.

4. The system of claim 1, wherein the fingerprint identification module is located on a remote server.

5. The system of claim 1, wherein the sensor array wrap, fingerprint identification module and application specific integrated circuit form a prefabricated assembly that can be over-laid on the surface of a fixture.

6. A biometric device for fingerprint recognition, comprising:
a scanner,
said scanner having a scanning surface that deforms to accept the bottom surface and sides of the finger, or hand, when the finger or hand is applied to the scanning surface,
said scanner comprising a sensor array wrap and a sensor array embedded in said sensor array wrap,
an application specific circuit for conversion of analog data from a captured fingerprint image from said sensor array into a digital image; and,
a fingerprint security application for verification of said digital image against stored fingerprint templates.

7. The system of claim 6, wherein the sensor wrap is selected from the group consisting of plastic, synthetic or natural rubber, glass and fiberglass.

8. The system of claim 6, wherein the scanner is over-laid on a fixture, or forms a part of the fixture.

9. The system of claim 6, wherein the fingerprint identification module is located on a remote server.

10. The system of claim 6, wherein the sensor array wrap, fingerprint identification module and application specific integrated circuit form a prefabricated assembly that can be over-laid on the surface of a fixture.

11. The system of claim 8, wherein the fixture is a door-knob.

12. The system of claim 8, wherein the fixture is a steering wheel.

13. The system of claim 8 wherein the fixture is a mouse pad.

14. The system of claim 8, wherein the fixture is a touch pad.

15. An apparatus for fingerprint recognition, comprising:
a scanner,
said scanner comprising scanner arrays and a scanner array wrap,
said scanner array wrap comprising a plurality of layers of material within which the scanner array is embedded,
said scanner array integrated into one of said plurality of layers;
an application specific circuit for conversion of a captured fingerprint analog image from said sensor array into a digital image; and
a fingerprint security application for verification of said digital image against stored fingerprint templates.

16. The system of claim 15, wherein the scanner array wrap is selected from the group consisting of plastic, synthetic or natural rubber, glass and fiber-glass.

17. A system of fingerprint recognition on a fixture, comprising:
electroluminescent polymer coating enveloped on the surface of said fixture for generating an illuminated image,
a detector sensor positioned on said object for detecting and capturing fingerprint data, said illuminated image reflected from finger placed on said electroluminescent polymer coating,
application specific circuit for conversion of said captured analog fingerprint image into a digital image, and,
a fingerprint security application module for verification of the said fingerprint image against stored fingerprint templates.

18. The system of claim 17, wherein an electroluminescent polymer coating, a detector array, a fingerprint identification module and an application specific integrated circuit form a prefabricated assembly that can be wrapped over the surface of an object.

19. The system of claim 18, wherein the fingerprint identification module is located on a remote server.

20. The system of claim 18, wherein the fingerprint identification module is located within the biometric device.
